(19) United States
(12) Patent Application Publication
(10) Pub. No.: US 2004/0054692 A1
(43) Pub. Date: Mar. 18, 2004

(54) Method for compressing/decompressing a structured document

(76) Inventors: Claude Seyrat, Paris (FR); Cedric Thienot, Paris (FR)

Correspondence Address: BACHMAN & LAPOINTE, P.C., 900 CHAPEL STREET, SUITE 1201, NEW HAVEN, CT, 06510, US

(21) Appl. No.: 10/470,373

(22) PCT Filed: Feb. 1, 2002
(86) PCT No.: PCT/FR02/00394

(30) Foreign Application Priority Data
Feb. 2, 2001 (FR) 01/01447

(51) Int. Cl. G06F 7/00

(52) U.S. Cl. 707/104.1; 707/101

(57) ABSTRACT

The invention concerns a method for compressing a structured document comprising nested information elements, the document being associated with at least a tree-like structure schema (1) defining a structure of the document and comprising of nested structural components, representing information elements, which consists in: analysing (11) and compiling (13) the structural schema of the document to obtain for each component of the schema, a sequence or executable instructions (5), comprising instructions for inserting control codes and codes of element or calling for sequences of component instructions, and instructions for controlling the development of the execution of the sequence on the basis of control code values; and decompressing (14′) the document to be decompressed (10) which is in the form of a bit stream, said step including execution of sequences of instructions (5) on the bit stream, to restore a document with original format.

This invention relates to a method for compressing and decompressing a structured document.

It is particularly but not exclusively applicable to transmission of documents such as images, video or sound data, through digital data transmission networks, and to storage of such documents and storage of data describing these documents.

A structured document is a collection of information elements, each associated with a type and attributes, and related to each other by mainly hierarchical relations. These documents use a structuring language such as SGML, HTML or XML, which in particular distinguishes the different information sub elements making up the document. On the contrary, in a so-called linear document, the information defining the document contents is mixed with presentation and typeset information.

A structured document includes separation markers for the different information sets in the document. In the case of SGML, XML or HTML formats, these markers are called “tags” and are in the form “<XXXX>” and “</XXXX>”, the first tag indicating the beginning of an information element “<XXXX>” and the second tag indicating the end of this set. An information element may be composed of several lower level information elements. Thus, a structured document has a hierarchical structure or tree-like structure schema, each node representing an information element and being connected to a node at a higher hierarchical level representing an information element that contains lower level information elements. Nodes located at the end of the branch of this tree-like structure represent information elements containing a predefined type of data that cannot be decomposed into information sub elements.

Thus, a structured document contains separation tags represented in the form of text or binary data, these tags delimiting information elements or sub elements that may themselves contain other information sub elements delimited by tags.

Furthermore, a structured document is associated with what is called a structure schema defining the structure and type of information in each information set in the document, in the form of rules. A schema is composed of nested groups of information set structures, these groups possibly being ordered sequences, or ordered or unordered groups of choice elements or groups of necessary elements.

At the present time, there are several digital document compression algorithms. Some compression algorithms are designed to process document binary data directly without considering the type of these data. These algorithms have the advantage that they can process any type of document, but their performance is not very good (low compression ratio) for use with large documents, which are usually of the sound or image type.

Other more efficient compression algorithms are known which are specially adapted to a data type, for example image or sound type of data, so that they cannot be used or are efficient if they are applied to documents that do not exclusively contain data of the type for which they were designed. Consequently, compression algorithms designed for use with a specific data type are not very efficient and badly adapted for handling structured documents containing different data types.

The purpose of this invention is to eliminate these disadvantages. This objective is achieved by providing a method for compressing a structured document comprising information elements nested in each other and each associated with an information type, the structured document being associated with at least one structure schema defining a document tree-like structure and comprising structure components nested in each other, each type of document information being defined by a component in the schema.

According to the invention, this method comprises steps consisting of analyzing the document structure schema in order to obtain a sequence of executable instructions for each component of the structure schema, comprising instructions for inserting control codes and compressed values of information elements or component instruction sequences call codes, instructions for controlling the execution of the sequence as a function of control code values, execution of the instruction sequences on the structured document compressing the structured document into a bit stream containing compressed values of information elements in the document.

Advantageously, this method also comprises a step for execution of instruction sequences on the structured document.

According to one special feature of the invention, the document comprising basic elements not decomposed into sub-elements, at least one type of basic element information is associated in advance with a compression algorithm adapted to the type of information, the method comprising application of the compression algorithm to the value of each information element with an information type associated with said algorithm, during execution of the instruction sequences.

According to another special feature of the invention, the method comprises a step for compilation of instruction sequences obtained for each component of said structure schema, to obtain a binary encoding program dedicated to said structure schema, and directly executable or interpretable by a computer to compress a document with the structure schema.

According to another special feature of the invention, the method comprises a prior step for normalization of the document structure schema, so as to obtain a single predefined order of components in the schema.

According to another special feature of the invention, the method comprises a prior step of optimizing and simplifying the document structure schema consisting of reducing the number of nesting levels in structure components.

Advantageously, at least one element of information in the document is associated with an information element code in the generated bit stream, which is marked so as to enable direct access to a particular compressed information element in the bit stream, without it being necessary to decompress information elements preceding the element to be decompressed in the bit stream.

According to yet another special feature of the invention, the generated compressed document comprises a code for each information element in the structured document, used to determine the type of information associated with the information element and the binary value of the information element.

According to yet another special feature of the invention, the document structure schema comprises the definition of sub-types of at least one type of information, and the instructions sequence generated for a component of a type with n sub-types comprises the following in sequence:

an instruction to insert a sub-type code representing a sub-type to be applied to an element corresponding to the component of the document, associated with the size of this code as a number of bits, and

instructions to test the value of the sub-type code, each test instruction being associated with a reference to the sub-type of the element corresponding to the tested value of the sub-type code, and an instructions sequence generated for compression of an element associated with the sub-type.

Preferably, the bit stream generated for a component corresponding to several occurrences of an elements set comprising at least one information element in the document, comprises a predefined end code.

According to yet another special feature of the invention, each component of the structure schema corresponds to an elements set in the document comprising at least one information element, and is also associated with a set of numbers of possible occurrences, indicating the number of times that an elements set corresponding to this component may appear in information element at a level immediately higher than the level to which it belongs.

According to yet another special feature of the invention, the instructions sequence generated for a component with a number of occurrences equal to 0 or 1 comprises, in sequence:

an instruction to insert a presence code on one bit indicating whether or not an elements set corresponding to the component is present in the document,

an instruction to test the value of the presence code, and

in association with the test instruction, if the value of the presence code indicates the presence of the elements set in the document, an instructions sequence generated for the component, independently of the associated number of occurrences.

According to yet another special feature of the invention, the instructions sequence generated for a component with a number of occurrences between n and m includes the following steps in sequence:

an instruction to insert a number of occurrences code indicating the number of successive occurrences of an elements set corresponding to the component in the compressed document, minus the minimum number n of occurrences, associated with the size of this code as a number of bits,

a loop instruction defining a number of iterations corresponding to the value of the number of occurrences codes, and

in association with the loop instruction, an instructions sequence that is generated for the component independently of the associated number of occurrences.

According to yet another special feature of the invention, the instructions sequence generated for a component with a number of occurrences between 0 and m also comprises:

an instruction to insert a presence code indicating whether or not there is at least one occurrence of the elements set corresponding to the component in the document, and

an instruction to test the value of the presence code associated with the instructions sequence generated for a number of occurrences of the component between 1 and m, if the value of the presence code indicates that at least one elements set is present.

According to yet another special feature of the invention, the instructions sequence generated for a component with a number of occurrences between n and m includes the following steps in sequence:

an instruction to insert a single-bit presence code signaling an occurrence of an elements set corresponding to the component in the document, associated with the size of this code as a number of bits,

a loop instruction to be executed as long as the presence code to be inserted indicates that a new occurrence of the elements set is present,

in association with the loop instruction, an instructions sequence generated for the component, and an instruction to insert a new single-bit presence code signaling a new occurrence of the elements set in the document.

According to yet another special feature of the invention, each component in the structure schema corresponds to an elements set comprising at least one information element, the structure schema of the structured document comprises at least one sequence type component of ordered components, in which the order of appearance in the sequence defies the order of appearance of element sets in the document corresponding to components of the sequence type group, and the instructions sequence generated for a sequence comprising n components comprises instruction sequences generated for each component in the sequence, successively.

According to yet another special feature of the invention, each component in the structure schema corresponds to an elements set comprising at least one information element, the structure schema of the document to be compressed comprises at least one component of the choice components group type, each choice component corresponding to an information elements set, the component of the choice components group type corresponding to one of the information sets in the document corresponding to choice components, and the instructions sequence generated for a group of choice components comprising n components defining n corresponding element sets, comprises the following in sequence:

an instruction to insert an elements set number code denoting which elements set among the n element sets appears in the document, associated with the size of this code as a number of bits, and

instructions to test the value of the elements set number code, each test instruction being associated with an instructions sequence generated for the component corresponding to the elements set corresponding to the tested value of the elements set number code.

According to yet another special feature of the invention, each component of the structure schema corresponds to an elements set comprising at least one information element, and the structure schema of the document to be compressed comprises at least one group of the unordered components type, each component in the unordered group corresponding to an elements set and the group of the unordered group type corresponding to a group in the document containing all element sets corresponding to components of the unordered type group, in an arbitrary order, and the instructions sequence generated for an unordered type group comprising n components corresponding to n element sets in the document, comprises the following in sequence:

an instruction to insert an elements set number code and denoting the next elements set appearing in the document associated with the size of the code as a number of bits, and

an instruction to test the value of the elements set number code, each test instruction being associated with an instructions sequence generated for the component corresponding to the elements set corresponding to the tested value of the elements set number code, and an instructions sequence generated for an unordered type group comprising all components in the unordered group except for the component corresponding to the element set.

The invention also relates to a method for decompressing a structured document comprising information elements nested in each other and each associated with an information type, the structured document being associated with at least one structure schema defining a tree-like structure of the document and comprising structure components nested in each other, each type of document information being defined by a component of the schema.

According to the invention, this method comprises steps consisting of analyzing the document structure schema in order to obtain a sequence of executable instructions for each component of the structure schema, this sequence comprising instructions for reading control codes and compressed values of information elements or call codes to call component instruction sequences, and instructions for controlling the execution of the sequence as a function of the control code values, in a bit stream forming the compressed document, the execution of instruction sequences on the compressed document being sufficient to restore a document in the same format as the original document and with an at least equivalent structure.

Advantageously, this method also comprises a step for execution of the instruction sequences on the bit stream forming the document to be decompressed.

According to a special feature of the invention, the structured document comprising basic elements not broken down into sub-elements and at least one basic elements information type, is associated with a decompression algorithm adapted to the information type, the method comprising the detection of an information element binary code corresponding to said information type in the bit stream, and application of the decompression algorithm to this binary code, during execution of instruction sequences on the bit stream forming the compressed document.

According to another special feature of the invention, the method comprises a step for compiling instruction sequences obtained for each component of said structure schema, to obtain a binary decoding program dedicated to said structure schema, and that can be directly executed or interpreted by a computer to decompress a document with this structure schema.

According to yet another special feature of the invention, the method comprises a prior step of normalizing the document structure schema, so as to obtain a single predefined order of the components of the schema.

According to yet another special feature of the invention, the method comprises a prior step of optimizing and simplifying the document structure schema consisting of reducing the number of hierarchical levels of structure component groups.

Advantageously, at least one information element code is identified in the bit stream of the compressed document, so as to enable direct access to this information element, without it being necessary to decompress information elements preceding this element in the bit stream.

According to yet another special feature of the invention, the compressed document comprises a code for each information element in the original document, to determine the information type associated with the information element and the binary value of the compressed information element.

According to yet another special feature of the invention, the structure schema of the document to be decompressed comprises the definition of sub-types of at least one information type, and the instructions sequence generated for a component of a type with n sub-types includes the following in sequence:

an instruction to read a sub-type code representing a number of the sub-type to be applied to an element corresponding to the component in the document, associated with the size of this code as a number of bits, and

instructions to test the value of the sub-type code, each test instruction being associated with a reference to the sub-type of the element corresponding to the value of the tested sub-type code, and an instructions sequence generated for decompression of an element associated with the sub-type.

Preferably, the end of a group of several occurrences of an elements set comprising at least one information element corresponding to a component of the schema, is marked in the bit stream of the compressed document by a predetermined binary code.

According to yet another special feature of the invention, each component in the structure schema corresponds to an elements set in the bit stream of the document, comprising at least one information element, and is also associated with a set of possible numbers of occurrences indicating the number of times that an elements set corresponding to this structure component can appear in the information element at a level immediately above the level to which it belongs.

According to yet another special feature of the invention, the instructions sequence generated for a component with a number of occurrences equal to 0 or 1 comprises the following in sequence:

an instruction to read a single-bit presence code indicating whether or not an elements set corresponding to the component is present in the compressed document,

an instruction to test the value of the presence code, and

in association with the test instruction, if the value of the presence code indicates that the elements set is present in the compressed document, an instructions sequence that is generated for the component independently of the associated number of occurrences.

According to yet another special feature of the invention, the instructions sequence generated for a component with a number of occurrences between n and m comprises the following in sequence:

an instruction to read a number of occurrences code indicating the number of successive occurrences in the compressed document of an elements set corresponding to the component, minus the minimum number n of occurrences associated with the size of this code as a number of bits,

a loop instruction defining a number of iterations corresponding to the value of the number of occurrences code, and

in association with the loop instruction, an instructions sequence generated for the component, independently of the associated number of occurrences.

According to yet another special feature of the invention, the instructions sequence generated for a component with a number of occurrences between 0 and m also comprises:

an instruction to read a single-bit presence code indicating whether or not there is at least one occurrence of an elements set corresponding to the component in the compressed document, and

an instruction to test the value of the presence code, associated with the instructions sequence generated for a number of occurrences of the component between 1 and n, if the value of the presence code indicates that there is at least one elements set present.

According to yet another special feature of the invention, the instructions sequence generated for a component with a number of occurrences between n and m comprises the following successively:

an instruction to read a single-bit presence code indicating whether or not there is an occurrence of an elements set corresponding to the component in the compressed document, associated with the size of this code as a number of bits,

a loop instruction to be executed as long as the presence code read in the bit stream of the compressed document indicates that there is a new occurrence of the element set,

in association with the loop instruction, an instructions sequence generated for the component, and an instruction to insert a new single-bit presence code indicating whether or not there is a new occurrence of the elements set in the compressed document.

According to yet another special feature of the invention, each component of the structure schema corresponds to an elements set comprising at least one information element, and the structure schema of the compressed document comprises at least one ordered components sequence type component, for which the order of appearance in the sequence defines the order of appearance of element sets in the document corresponding to components of the sequence type group, and the instructions sequence generated for a sequence comprising n components comprises instruction sequences generated for each component in the sequence successively.

According to yet another special feature of the invention, each component in the structure schema corresponds to an elements set comprising at least one information element, and the structure schema of the document to be decompressed comprises at least one component of the choice components group type, each choice component corresponding to an information elements set, the component of the choice components group type in the document corresponding to one of the information sets corresponding to the choice components, and the instructions sequence generated for a choice components group comprises n components defining n element (X1, X2, . . . , Xn) sets respectively, comprises the following in sequence:

an instruction to read an elements set number code denoting the elements set that appears in the document among the n element sets, associated with the size of this code as a number of bits, and

instructions to test the value of the elements set number code, each test instruction being associated with an instructions sequence generated for the component corresponding to the elements set corresponding to the tested value of the elements set number code.

According to yet another special feature of the invention, each component of the structure schema corresponds to an elements set comprising at least one information element, the structure schema of the document to be compressed comprises at least one group of the unordered components type, each component in the unordered group corresponding to an elements set and the group of the unordered group type corresponding to a group in the document containing all element sets corresponding to components of the unordered type group in an arbitrary order, and the instructions sequence generated for an unordered type group comprising n components corresponding to n element sets in the document, comprises the following successively:

an instruction to read an elements set number code and denoting the next elements set appearing in the document, associated with the size of this code as a number of bits, and

instructions to test the value of the elements set number code, each test instruction being associated with an instructions sequence generated for the component corresponding to the elements set corresponding to the tested value of the elements set number code, and an instructions sequence generated for an unordered type group comprising all components in the unordered group except for the component corresponding to the element set.

A preferred embodiment of the invention will now be described as a non-limitative example, with reference to the appended drawings, wherein:

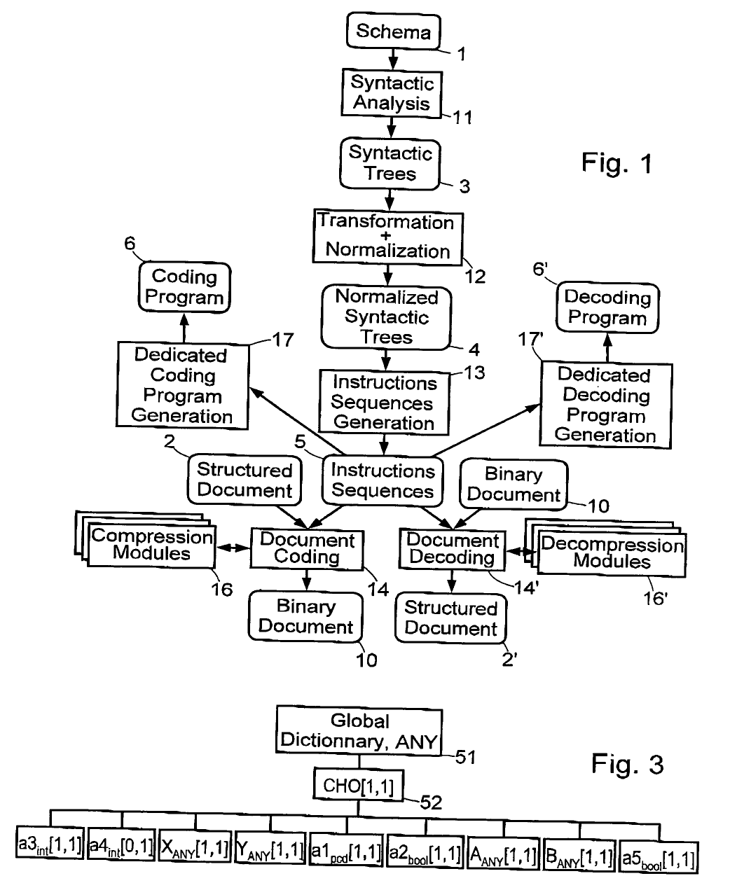

FIG. 1 shows the different steps in the method according to the invention in the form of a block diagram;

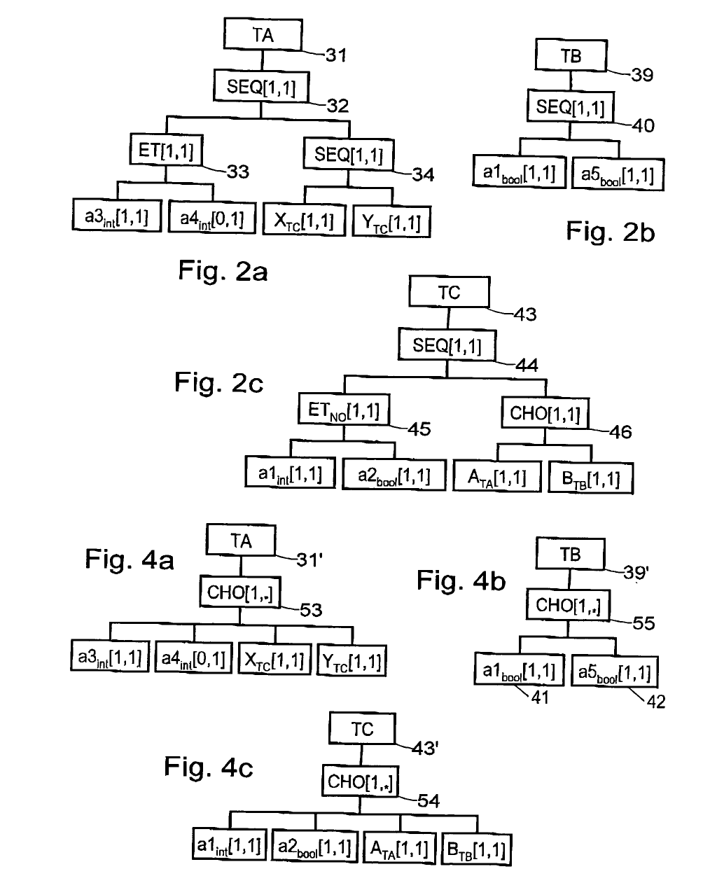

FIGS. 2a, 2b and 2c graphically show a tree-like structure schema;

FIG. 3 shows a structure schema obtained by applying a reduction method according to the invention to the structure schema shown in FIG. 2;

FIGS. 4a, 4b and 4c show a structure schema obtained by applying another reduction method according to the invention to the structure schema shown in FIG. 2.

FIG. 1 shows the chaining of the different steps in the method according to the invention.

This method is designed to handle a structured document composed of a structure schema 1 defining the document structure and structured information 2 of the document.

For example, the following shows the form of one stricture schema using the XML-Schema language:

```
<elementname=“C”>
  <complexType>
    <Choice>
      <element name=“A” type=“TA” minOccurs=1 maxOccurs=1/>
      <element name=“B” type=“TB” minOccurs=1 maxOccurs=1/>
    </Choice>
    <attribute name=“a2” required=false type=“boolean”/>
    <attribute name=“a1” required=false type=“integer”/>
  <complexType>
<element>
```

This schema indicates that the structure component named “C” has a complex structure composed of a first optional Boolean type attribute named “a2”, a second integer type attribute named “a1” that is always present in the structure, and a group of choice components named “A” and “B” with types “TA” and “TB” respectively, one of these two components only being present in the structure once.

Types “TA” and “TB” are defined in the document structure schema by an analogue formulation.

In general, particular components called component groups are used to define a document structure. These component groups may be of the following type:

SEQ that defines a list of ordered components, in which the corresponding elements of the document must all appear and must be in the indicated order,

CHO that defines a group of choice components, a single element corresponding to a component of the group that must appear in the document,

AND that defines a group of components for which the corresponding elements must all appear in the document and in an arbitrary order that must not be modified; this group corresponds to the “all” group in the XML Schema standard,

AND_{NO} that defines a components group for which the corresponding elements must all be present in the document in an arbitrary order which is unimportant; this group may be used for encoding attributes for which the order is not important in the XML standard, and

ANY that includes any element among all the possible elements that can be found in the document.

According to the invention, this formulation is analyzed and transformed in step 11 of the method to obtain syntactic trees 4, with one tree for each structure component. The syntactic tree corresponding to the component with structure TC is symbolized by the following expression:

TC->SEQ[1,1](AND_{NO}[1,1](a1ᵢₙₙ[1,1],a2_{bool}[0,1]),CHO[1,1]A_{TA}[1,1],B_{TB}[1,1])

in which:

“A[x,y]” indicates that the component “A” corresponds to an element repeated from x to y times in the document, and that can be equal to “*” representing an undetermined value.

This expression may be represented by the tree shown in FIG. 2c, comprising a root component “TC” 43 composed of a single occurrence of a group of sequence type components 44. This group comprises a single occurrence of an unordered group of “AND” type components 45 and a single occurrence of a group of choice components 46. The group 45 is composed of a single occurrence of an integer named “a1” and a Boolean named “a2”, and the group 46 comprises a single occurrence of an element type “TA” named “A” and an element type “TB” named “B”.

Types “TA” and “TIB” obtained in step 11 may for example be given by the following formulas:

TA->SEQ[1,1](AND[1,1](a3ᵢₙₜ[1,1],a4ᵢₙₜ[0,1]),SEQ[1,1](X_{TC}[1,1],Y_{TC}[1,1]))

TB->SEQ[1,1](a1_{bool}[1,1],a5_{bool}[1,1])

and represented by the trees shown in FIGS. 2a and 2b respectively.

Type “TA” 31 comprises a single sequence type group 32 composed of two single groups 33, 34 of types AND and SEQ respectively. The group 33 comprises two single integer type occurrences called “a3” and “a4” respectively. The group 34 comprises two single “TC” type occurrences named “X” and “Y” respectively.

Type “TB” 39 is composed of a single sequence type group 40 comprising two Booleans named “a1” and “a5” respectively.

Although a distinction is made between the name of each element and its type in the above description, the method according to the invention is also applicable to structuring languages that do not make this distinction.

Furthermore, some languages such as the XML Schema language enable what is called “polymorphism” or the use of sub-types.

These sub-types are defined as follows:

```
<complexType name=“TA1”>
  <restriction base=“TA”>
  </restriction>
</complexType>
<complexType type=“TA2”>
  <extension base=“TA”>
  </extension>
</complexType>
<element name=“X” type=“TA/>
```

This syntax defines types TA1 and TA2 as sub-types of type TA by restriction or extension, and the information component X of type TA.

A document with this structure schema can include a type TA1 element X that may be added as follows:

<X xsi:type=“TA1”>

Furthermore, some types that possess sub-types in this way may be declared to be abstract, which means that information elements in a document with a structure schema comprising the definition of an abstract type do not necessarily contain information elements of his type. Abstract elements are only used to create hierarchies or type classes. An abstract type is defined as follows in the XML Schema language:

<complexType name=“a” type=“TA” abstract=“true”>
</complexType>

Furthermore, structure components must be deterministic, in other words it must not be possible to interpret an element of the document in more than one way. For example, in the “CHO(a,SEQ(a,b))” schema, in the case in which “a” appears in the document, it is impossible to know whether or not “b” has to appear afterwards. There are algorithms for this purpose that can be applied using the method according to the invention to transform a non-deterministic schema into a deterministic schema. For example, refer to the documents [“Regular expressions into finite automata” Brüggemann-Klein, Anne, Extended Abstract in I. Simon, Hrsg., LATIN 1992, S. 97-98 Springer-Verlag, Berlin 1992. Full Version in Theoretical Computer Science 120: 197-213, 1993]. Thus, the schema mentioned above could be replaced by “SEQ(a,b[0,1])”.

In the next step 12 of the method according to the invention, processing can then be done on the components of the structure schema transformed into syntactic trees, to reduce or simplify them.

For example, this reduction processing may consist of a globally flattening method to generate a single syntactic tree 51 from all the trees 31, 39 and 43 as shown in FIG. 3.

This tree actually shows a dictionary of all element types that might be encountered in the document, these elements being collected into a choice type group 52 appearing at least once [1,*] in the document. In this tree, complex type components “A”, “B”, “X” and “Y” are associated with an “ANY” type, and component “a1” that appeared twice (in components “TB” and “TC”) with different types, is associated with a default “pcdata” type according to the XML language, or with the element type in the initial document, for example text. The same information element may actually be represented in different ways; for example, a binary sequence may also be considered as a character string or an integer number.

As a variant, this reduction processing consists of locally flattening the syntactic trees to obtain the trees represented as 31′, 39′ and 43′ in FIGS. 4a to 4c.

In each of these figures, groups 32 to 34 (FIG. 2a), 40 (FIG. 2b) and 44 to 46 (FIG. 2c) have been replaced by a choice type group 53, 54, 55 appearing at least once [1,*].

Trees “TA”, “TB” and “TC” may also be further processed to eliminate ambiguities appearing in the structure schema.

In some cases, syntactic trees may be simplified non-destructively, while improving the compactness of the binary code that can be generated.

This type of simplification may be done in the case of a group of components containing a single component X for which the minimum number of occurrences nₓ is equal to 0 or 1, in the following form:

GROUP[n_{G},m_{G}](X[nₓ,mₓ])

in which GROUP may be a SEQ, CHO or AND type group. A group may be replaced by the following component:

X[n_{G}.nₓ,m_{G}.mₓ]

Another case of non-destructive simplification is possible in the case of a group of choice components CHO, comprising at least one component for which the minimum number of occurrences is equal to 0. Thus the group:

CHO[0,m_{c}](X₁[nₓ₁,mₓ₁],X₂[1,mₓ₂],X3[nₓ₃,mₓ₃])

can be replaced by:

CHO[n_{c},m_{c}](X₁[nₓ₁,mₓ₁],X₂[0,mₓ₂],X3[nₓ₃,mₓ₃]).

Similarly, a group CHO[1,1]( . . . , CHO[1,1]( . . . ), . . . ) with a single CHO type occurrence particularly containing a single CHO type occurrence may be simplified by replacing it by a single CHO[1,1]( . . . ) group of the CHO type containing all components in the two CHO type groups.

In step 12, trees “TA”, “TB” and “TC” are also subjected to a normalization processing that consists of reordering the schema so as to obtain a single order of components in the schema. This processing then assigns a binary number to the different nodes of the syntactic trees obtained following the previous processing. This number is used during compression of the corresponding information element.

In particular, the normalization processing consists of attributing a signature to each group, generated by concatenation of a group name with the signature of all components in the group, previously put into order. Thus, group 53 in FIG. 4 is associated with the “CHO.a3.a4.X.Y” signature.

During this processing, it is considered that the ordered groups (SEQ) are already normalized. Therefore, the: groups to be normalized are choice type groups (“CHO”), and “AND” and “AND_{NO}” groups. This processing comprises the following steps for each group G composed of sub-groups gᵢ and components eᵢ defining a corresponding element in the document:

normalization of sub-groups gᵢ, if any, in group G before group G is normalized, the normalization algorithm being recursive,

storage of components eᵢ, if any, in group G before the sub-groups gᵢ,

storage of components eᵢ in a predefined order,

storage of sub-groups gᵢ in the predefined order, and

determination of the signature of group G given by concatenation of all signatures of its components (and sub-groups) in the order produced after the above steps.

The predefined order for storage of group components may be alphanumeric order of their corresponding signatures, or decreasing order of their minimum number of occurrences, and in this case components with the same minimum number of occurrences are stored in alphanumeric order.

Note that this normalization processing is not necessary for the method according to the invention. The order in which components appear in the schema can be conserved.

The next step 13 in the method consists of generating an instructions sequence 5, also called the “binary syntax” describing a bit stream. This processing consists of generating an instructions sequence for each syntactic tree or complex type in the structure schema, beginning with nodes or components at the lowest level in the syntactic trees in the document tree-like structure schema. Call instructions to binary syntaxes thus generated for the lowest level nodes are then inserted in binary syntaxes for the higher level nodes in which the low-level components appear. The result is that a binary syntax is obtained for the entire document structure schema, which calls the binary syntaxes for lower level components, in the same way as software comprising a main program that calls sub-programs, which can then call other subprograms, and so on.

The binary syntax of a component representing an element X of type TX is in the following form:

| | |
|---|---|
| X | TX |

where “X” represents an instruction to insert or to read the value of the element X or to call the instructions sequence corresponding to element X, and “TX” represents a reference to the type of element X.

If type TX has one or several sub-types, it represents what is called polymorphism. In this case, it is associated with the following binary syntax:

| | |
|---|---|
| X | TX poly |

If the type TX comprises sub-types S1, S2, . . . , Sn, two different cases have to be considered depending on whether or not the default type TX is abstract.

If the default type TX is abstract, then a “TX_poly” binary syntax comprises the following in sequence:

an instruction to insert or read a code of sub-type “flagPoly” representing a number of the sub-type to be applied to element X, associated with the size of this code as a number of bits, and

instructions to test the value of the sub-type code, each test instruction being associated with an instruction to insert or read the value of element X or to call the instructions sequence corresponding to element X associated with a reference to the sub-type of element X corresponding to the tested value of the sub-type code.

Sub-types S1, . . . , Sn are arranged in the order of their signatures, before this operation:

for example, this type of binary syntax may be in the following form:

TABLE 1

| | |
|---|---|
| flagPoly | E(log₂(n)) bits |
| if (flagPoly=0){ | |
| X | S₁ |
| } | |
| else if (flagPoly=1){ | |
| X | S₂ |
| } | |
| ... | |
| else if (flagPoly=k) { | |
| X | Sₖ₊₁ |
| } | |
| ... | |
| else if (flagPoly=n−1){ | |
| X | Sₙ |
| } | |

where E( ) is a function rounding tip to the next higher integer, and “flagpoly” contains the number code of the sub-type to be applied to element X, and “X” indicates the positions at which the code for element X must be inserted.

If 2^{E(log}^{₂}⁽ⁿ⁾⁾>n, the following line can be added at the end of the binary sequence to detect malfunctions:

| | |
|---|---|
| Else | SpecificProcess |

where “SpecificProcess” is a procedure designed to signal a processing error in the case in which the value of “flagPoly” does not correspond to a sub-type of TX.

If the default type TX is not abstract, the binary syntax of TX_poly is obtained by inserting the previous binary syntax into a binary syntax comprising the following successively:

an instruction to insert or read a single-bit “typInfoFlag” sub-typing presence code indicating if the element type is the default type or a sub-type of this default type, and

an instruction to test the value of the sub-typing presence code, and

in association with the test instruction, the instructions sequence defining polymorphism like that indicated in Table 1, if the value of the sub-typing presence code indicates that the element type is a sub-type, and otherwise an instruction to insert or read a value of the element X associated with a reference to the default type of element X.

For example, this type of binary syntax may be in the following form:

TABLE 2

| | |
|---|---|
| typeInfoFlag | 1 bit |
| if (typeInfoFlag) { | |

Binary syntax of Polymorphism

}
else

| | |
|---|---|
| X | TX |

in which “typeInfoFlag” is a code indicating if the type of X is TX or one of the sub-types of TX.

The next step is to determine the binary syntax of the number of occurrences [n,m] of each element or elements set X for which the binary syntax has been determined. Afterwards an element can represent an elements set.

A distinction is made between three cases for this purpose. In a first case, m and n are equal to 1, in other words component X is associated with occurrence numbers [1,1]. The binary syntax produced corresponds to the binary syntax generated for component X.

In the second case, n=0 and m=1, the binary syntax generated comprises the following successively:

an instruction to insert or read a single-bit presence code “flagX” indicating whether or not element X is present in the compressed document, associated with the size of this code as a number of bits,

an instruction to test the value of the presence code, and

in association with the test instruction, an instruction to insert or read the value of the element X or calling the instructions sequence corresponding to the element X, if the value of the presence code indicates that the element X is present in the document.

For example, this type of binary syntax may be in the following form:

TABLE 3

| | |
|---|---|
| FlagX | 1 bit |
| if (flag X) { | |

binary syntax of X

}

in which flagX is a single-bit code indicating whether or not X is present in the document. This binary syntax is similar to a sequence of programming instructions in which X is inserted if the value of the indicator flagX is equal to “true”.

In the third case, m−n is less than a predetermined threshold constant, for example 2¹⁶ (=65536), which means that the number of occurrences may be encoded in the form of an unsigned 16-bit integer. In this case, the binary syntax of element X[n,m] comprises the following successively:

an instruction to insert or read a number of occurrences code “loopflagX” indicating the number of successive occurrences of element X in the compressed document, minus the minimum number n of occurrences of element X associated with the size of this code as a number of bits,

a loop instruction defining a number of iterations corresponding to the value of the number of occurrence codes, and

in association with the loop instruction, an instruction to insert or read the value of the element X or calling an instructions sequence corresponding to element X.

For example, this type of binary syntax may be in the following form:

TABLE 4

| | |
|---|---|
| loopflagX | E(log₂(m−n+1)) bits |
| for (k=0;k<loopFlagX+n;k++) { | |
| binary syntax of X | |
| } | |

in which “loopflagX” is the code of the number of successive occurrences of X in the document, minus the minimum number n of occurrences of X and E( ) is the function rounding up to the next higher integer.

This syntax indicates that “loopflagX” is encoded on E(log₂(m−n+1.)) bits, and that X must be inserted (loopflagX+n) times.

In the fourth case, in is not bounded or m−n is greater than the predetermined threshold constant. The binary syntax generated is similar to the binary syntax for the third case, except that “loopflagX” is not encoded on E(log₂(m−n+1)) bits, but it is encoded in another format in which any integer can be encoded.

For example, this format may be the “UINT_VLC” format composed of sets of a predetermined number of bits, for example 5 bits, the first bit of each set indicating whether or not this set is the last set in the code of the integer number, and the next four bits of the set are used to code the integer number.

In the third and fourth cases, if the minimum number of occurrences n is 0, it is preferable to add a binary syntax also comprising:

an instruction to insert or read a single-bit “shuntflagX” presence code, to

indicate whether or not at least one element X is present in the compressed document, and

an instruction to test the value of the presence code, associated with the instructions sequence generated for a number of occurrences of the element X between 1 and m, if the value of the presence code indicates that at least one element X is present.

For example, this type of binary syntax may be in the following form:

TABLE 5

| | |
|---|---|
| shuntFlagX | 1 bit |
| if (shuntFlagX) { | |

binary syntax of X[n,m]

}

in which “shuntFlag” denotes a single-bit code indicating whether or not the number of occurrences is 0, and the “binary syntax of X[n,m]” line is the binary syntax of the number of occurrences X corresponding to the third or to the fourth case.

As a variant, another type of encoding can be chosen in which there is no need to input the number of occurrences of elements of a structure schema. This type of encoding uses a binary syntax comprising the following successively:

an instruction to insert or read a single-bit “flagX” presence code indicating if there is an occurrence of element X in the document, associated with the size of this code as a number of bits,

a loop instruction to be executed as long as the presence code to be inserted or read indicates the presence of a new occurrence of element X,

in association with the loop instruction, an instruction to insert or read the value of element X or calling an instructions sequence corresponding to element X, and an instruction to insert or read a new single-bit “flagX” presence code indicating if there is a new occurrence of element X in the document.

For example, this type of binary syntax may be in the following form:

TABLE 6

| | |
|---|---|
| FlagX | 1 bit |
| while (flagX) { | |

| Binary syntax of X | |
|---|---|
| FlagX | 1 bit |

}

This solution has the advantage that there is no need to analyze the entire structure schema of the document to determine the minimum and maximum numbers of occurrences of each element in the structure.

The binary syntax of a sequential type group SEQ(X1, X2, . . . , Xn) comprises sequences of instructions generated successively, for sequence type group components, or calling of these instruction sequences

For example, this type of binary syntax may be in the following form:

binary syntax of X1
binary syntax of X2
.
.
.
binary syntax of Xn

The binary syntax of a choice group CHO(X1, X2, . . . , Xn) comprises the following, successively:

an instruction to insert or read a component number code “flagChoX” representing a component number Xi (i=1 . . . n) and denoting the next element Xi in the group to be inserted or read in the compressed document, associated with the size of this code as a number of bits, and

instructions to test the value of the element number code, each test instruction being associated with an instruction to insert or read the value of element Xi or calling an instructions sequence corresponding to element Xi corresponding to the tested value of the component code.

For example, this type of binary syntax may be in the following form:

TABLE 8

| | |
|---|---|
| flagChoX | E(log₂n)) bits |
| if (flagCho=0) { | |
| binary syntax of X1 | |
| } | |
| elseif (flagCho=1) { | |
| binary syntax of X2 | |
| } | |
| ... | |
| elseif (flagCho=n−1) { | |
| binary syntax of Xn | |
| } | |

where n is the number of components in the group and “flagCho” is the component code to be selected in the CHO group.

As above, if 2^{E(log}^{₂}⁽ⁿ⁾⁾>n, the following line can be added at the end of the binary syntax to detect malfunctions:

| | |
|---|---|
| Else | SpecificProcess |

This instruction calls an error signaling procedure if the value of the indicator “flagCho” does not correspond to one of the components expected in the CHO group.

If the number of occurrences is not encoded an unused value of “flagCho” may also be used (if 2^{E(log}^{₂}⁽ⁿ⁾⁾>n) to mark the last occurrence of group CHO:

TABLE 9

| | |
|---|---|
| flagCho | E(log₂(n)) bits |
| while (flagCho!=n) { | |
| if (flagCho=0) | |
| binary syntax of X1 | |
| } | |
| elseif (flagCho=1) { | |
| binary syntax of X2 | |
| } | |
| ... | |
| elseif (flagCho=n−1) { | |
| binary syntax of Xn | |
| } | |
| flagCho | E(log₂(n)) bits |
| } | |

The binary syntax of the AND group is generated by a recursive procedure. It consists of nesting CHO type groups, each determining which element is present in the description.

More precisely, this type of binary syntax is generated by making a distinction between two cases, the first case in which the group contains only one component, and the second case in which the group contains several components. If the group contains only one component, the binary syntax of such a group is the same as the binary syntax of a sequence type group with a single component.

If the group contains n components, it may be written in the form AND (X₁, X₂, . . . , Xₙ). The binary syntax of such a group comprises the following successively:

an instruction to insert or read a component number code “flagChoX” representing a component number Xi of the group and denoting the next element Xi of the group to be inserted or read in the compressed document, associated with the size of this code as a number of bits, and

instructions to test the value of the component number code, each test instruction being associated with an instruction to insert or read the value of the element Xi or calling an instructions sequence corresponding to element Xi corresponding to the tested value of the component code, and an instructions sequence generated for an “unordered group” type group comprising all components X1, . . . , Xn in the group except for component Xi.

For example, this type of binary syntax may be in the following form:

TABLE 10

| | |
|---|---|
| FlagChoX | E(log₂(n)) bits |
| if (flagCho=0) { | |
| binary syntax of X₁ | |

```
  binary syntax of AND(X₂, ..., Xₙ)
}
Elseif (flagCho=1) {
  binary syntax of X₂
  binary syntax of AND(X₁, X₃, ..., Xₙ)
}
...
Elseif (flagCho=k−1) {
  binary syntax of Xₖ
  binary syntax of AND(X₁, ..., X_{K-1}, X_{K+1}, ..., Xₙ)
}
...
Elseif (flagCho=n−1) {
  binary syntax of Xₙ
  binary syntax of AND(X₁, X₂, ..., Xₙ₋₁)
}
```

This binary syntax is obtained starting from the binary syntax of a CHO(X₁, X₂, . . . , Xₙ) group in which the binary syntax of a group AND(X₁, . . . , Xₖ₊₁, . . . , Xₙ) from which component Xₖ has been removed, has been added following the binary syntax of each component Xₖ in the group (where k is between 1 and n). Therefore this binary syntax is recursive.

The binary syntax of the AND_{NO} type group is identical to the binary syntax of an SEQ group, in which the encoding can also be optimized by adopting an appropriate order of components in the group.

The next step 14 consists of reading the document 2, compressing the data contained in it by executing the binary syntaxes that were generated on the document structure in order to obtain a bit stream containing a sequence of binary codes in which the compressed value of each element or basic information element of the document is located.

More precisely, the objective is to start from the contents of the document, and determine values of the different “typeInfoFlag”, “flagX”, “loopflagX”, . . . codes defined by the binary sequences, to be inserted in the bit stream.

According to a first encoding type, this bit stream is in the form (K.N.Vₜ . . . V_{N})ₑ for each element e, where N is the number of occurrences of the element e or the number of successive information elements corresponding to element e, K is the code used to determine the element e, and V₁ . . . V_{N} are the corresponding values, possibly compressed, of the N occurrences of element e. If e is a group of elements, its value V is broken down into as many binary sequences (K.N.V) as there are elements contained in it. However, N may be omitted in some cases, particularly when this number is fixed. The same is true for K, for example in the case of a sequence type group.

As a comparison, considering the extended duration representation format as defined by standard ISO 8601:

sPnYnMnDTnHnMnS

where s is the “+” or “−” sign, nY represents a number of years (infinite integer), nM is a number of months (infinite integer), nD a number of days (infinite integer), “T” is a separating character between the date and the time, nH is a number of hours (infinite integer), nM is a number of minutes (infinite integer) and nS is a number of seconds (decimal), all these elements being optional.

This format corresponds to a structure schema that may be represented as follows:

(\+|\−)P(\d+Y)?(\d+M)?(\d+D)?(T(\d+H)?(\d+M)?(\d+(\,\d+)?S)?)?

where “\+” indicates insertion of the “+” character, “(x|y)” indicates insertion of element x or y, “?” indicates that insertion of the previous element is optional, and “\d+” represents a binary number on an arbitrary number of bits.

The following shows an example of the structure of this type of binary syntax:

TABLE 11

| Duration | Number of bits |
|---|---|
| Sign | 1 |
| YearDefined | 1 |
| if (YearDefined) | |
| Years | UINT_VLC |
| MonthDefined | 1 |
| if (MonthDefined) | |
| Month | UINT_VLC |
| DayDefined | 1 |
| if (DayDefined) | |
| Day | UINT_VLC |
| HoursDefined | 1 |
| if (HoursDefined) | |
| Hours | UINT_VLC |
| MinutesDefined | 1 |
| if (MinutesDefined) | |
| Minutes | UINT_VLC |
| SecondsDefined | 1 |
| if (SecondsDefined) | |
| Seconds | UINT_VLC, UINT_VLC |

in which the value Sign is equal to 0 to represent the “+” sign, and 1 to represent the “−” sign.

Thus, the duration “+P1347Y” is encoded as follows:

| + | +1347Y | M | D | H | M | S |
|---|---|---|---|---|---|---|
| 0 | 1101010010000011 | 0 | 0 | 0 | 0 | 0 |

This encoding system requires 22 bits, while conventional encoding requires 48 bits. The duration “−P1Y2MT2H” is encoded as follows:

| − | 1Y | 2M | D | 2H | M | S |
|---|---|---|---|---|---|---|
| 1 | 100001 | 10010 | 0 | 100010 | 0 | 0 |

namely on 22 bits instead of 72 necessary for conventional encoding

Before this is done, a general header can be produced for the compressed document that contains several encoded parameters useful for the document description. Thus, this type of header may comprise a signature of the structure schema(s) used, and a set of parameters defining the encoding used, for example as follows:

a parameter indicating if encoding of the length of each element is compulsory or optional, or if it is not present in the document,

a parameter indicating whether or not elements may be sub-typed, in other words associated with a more precise type than their basic type, and

a parameter indicating the encoding type used for the number of occurrences.

Each information element in the document can also be associated with a header, its presence and nature being specified in the document header.

An element header may also comprise the encoded length of the element, so as to enable access to a particular element while the document is being decompressed without decompressing all previous elements in the document. Element headers are inserted in the document, for example just before encoding the value of elements.

In general, decompression of the document consists of sequentially reading the compressed document, by executing binary syntaxes generated from the schema on the bit stream obtained by sequentially reading the compressed document. This processing also provides a means of verifying that the structure of the compressed document corresponds to the schema compiled in binary syntaxes.

When the number of occurrences of elements in the structure schema is not encoded, the form of the element encoding is simply KV, the encoding of each elements set of the same type terminating with a K_{csc} bit equal to 0.

This type of encoding is only useful for encoding complex forms, and for elements in which there is no maximum number of occurrences or in which the minimum number of occurrences is zero. In particular, it is ideal for encoding choice type groups, comprising a number of elements not equal to 2^{p}, where p is an integer number.

This type of encoding may be combined with the previous type. In this case, all that is necessary is to include it in the header of the compressed document and to assign a bit to the encoding locations at which several occurrences must be located.

According to the invention, at least one basic type of information elements for the document is associated with an external compression module 16. In this way, the corresponding types of information elements encountered are analysed when the document is being read, and when an information type is associated with an external compression module 16, it is applied to the contents of the information element and the result of the compression is inserted in the compressed document as the value of the corresponding information element.

For example, external compression modules may use the “mp3” standard for sound information, or “jpeg” for images and “MPEG1” or “MPEG2” for video type data, or IEEE 754 for real number type values or UTF8 for character strings.

If none of the compression modules is associated with an information type, a default compression module may be used or information elements of this type may be retrieved in the same way as they appear in the initial document.

For example, encoding of the CHO[0,*](a1, a2, a3) structure produces the following binary syntax:

TABLE 12

| | |
|---|---|
| loopflagCho | UINT_VLC bits |
| for (k=0;k<loopFlagCho;K++) { | |
| flagCho | 2 bits |
| if (flagCho=0) { | |
| value Vₐ₁ of a1 | |
| } | |
| elseif (flagCho=1) { | |
| value Vₐ₂ of a2 | |
| } | |
| elseif (flagCho=2) { | |
| value Vₐ₃ of a3 | |
| } | |
| } | |

If we now want to code the occurrence “a₂ a₃ a₁ a₁ a₃” with this structure, the result of the encoding is as follows if the number of occurrences is encoded:

00101 01 Vₐ₂ 10 Vₐ₃ 10 Vₐ₁ 00 Vₐ₁ 10 Vₐ₃

in which “00101” represents the binary value of the number of occurrences, which is equal to 5 in the “UINT_VLC” format and Vₐ₁, Vₐ₂ and Vₐ₃ are the values of occurrences of a₁, a₂ and a₃ respectively.

If the number of occurrences is not encoded, the encoding is as follows:

01 Vₐ₂ 10 Vₐ₃ 00 Vₐ₁ 00 Vₐ₁ 10 Vₐ₃ 11

“11” is the end code for the number of occurrences which in this case is integrated into the selection code of the CHO group.

In the first case, the result is that element values are encoded on not more than 15 bits, whereas the second case gives a more compact encoding on 12 bits.

The structure of the encoding processing for occurrence “b₂ b₁ a₁” is as follows:

SEQ[0,*](a₁[0,*],CHO[0,*](b₁,b₂))

giving the following binary syntax:

TABLE 13

| | |
|---|---|
| shuntFlagSeq | 1 bit |
| if (shuntFlagSeq) { | |
| loopflagSeq | UINT_VLC bits |
| for (k=0;k<loopFlagSeq;k++) { | |
| shuntFlaga1 | 1 bit |
| if (shuntFlaga1) { | |
| loopflaga1 | UINT_VLC bits |
| for (k=0;k<loopFlaga1;k++) { | |
| value code Vₐ₁ of a1 | |
| } | |
| } | |
| shuntFlagCho | 1 bit |
| if (shuntFlagCho) { | |
| loopflagaCho | UINT_VLC bits |
| for (k=0;k<loopFlagCho;k++) { | |
| flagCho | 1 bit |
| if (flagCho=0) { | |
| value code V_{b1} of b₁ | |
| } | |
| elseif (flagCho=1) { | |
| value code V_{b2} of b₂ | |
| } | |
| } | |
| } | |
| } | |
| } | |

The encoding for this binary syntax is as follows:

1 number of occurrences of the sequence not equal to 0

00010 number of occurrences of the sequence (in this case twice)

0 number of occurrences of a=0

1 number of occurrences of CHO not equal to 0

00010 number of occurrences of CHO (twice)

1 choice code for b₂

V_{b2} encoding value of b₂

0 choice code for b₁

V_{b1} encoding value of b₁

1 number of occurrences of a=0

00001 number of occurrences of a₁ (once)

Vₐ₁ encoding value of for a₁

0 number of occurrences of CHO=0

If the order of the attributes is not useful (as in the XML language), encoding may be done to reorder attributes of the elements in a predetermined order, for example in alphanumeric order, and then depending on whether or not they are required. This arrangement correspondingly reduces the size of the compressed description.

If the document header contains an indication that the encoding of the length is optional or compulsory, elements are associated with a header in the compressed document containing the length of the value of the element as a number of bits. This feature enables direct access to an element in the compressed document, without needing to decompress elements before it in the document, using binary syntaxes to read only the corresponding lengths of these elements as far as the searched element.

The length of elements may be encoded as follows.

If the document header includes an indication that the encoding of element length is compulsory, the length L of elements as a number of bits is calculated using the following formula:

L=8*p+h (1)

where p represents the number of bytes (in ANSI encoding or using the high order bits of each byte used to code this number) used to code the element length, and h is the number of remaining bits with this length (h<8).

Note that the external compression module 16 called to code the value of an element may supply this length in return.

If it is not compulsory to code the length of the elements, the value of the first bit corresponding to the value of the element indicates whether or not the next bits represent the length of the element.

Decompression a document compressed in this way is done by executing steps 11 to 14 on the document structure schema to obtain binary syntaxes of structure components of the document structure schema, and then executing step 14′ to decode or decompress the document, this step consisting of browsing through the compressed document executing binary syntaxes obtained following steps 11 to 14 so as to be able to determine the type and name of compressed information elements found in the document. The values of elements obtained using external compression modules 16 are decompressed using the corresponding decompression modules 16′.

Note that if several documents with the same structure schema have to be processed (compressed or decompressed), steps 11 to 13 are only executed once, and only steps 14 and 16 (or 14′ and 16′) have to be applied to each document to be processed.

Furthermore, the binary syntax of a structure schema that is similar to a conventional programming language, may, be compiled 17, 17′ using an appropriate conversion processing, to generate binary code for a compression or decompression program 6, 6′ that can be directly executed or interpreted by a computer processor. Therefore, the method according to the invention is capable of automatically generating executable and therefore very fast compression and decompression programs dedicated to a given structure schema.

1. Method for compressing a structured document comprising information elements nested in each other and each associated with an information type, the structured document (2) being associated with at least one structure schema (1; 31, 39, 43) defining a document tree-like structure and comprising structure components (a3, a4, X, Y, a1, a5, a1, a2, A, B, 32, 33, 34, 40, 44, 45, 46) nested in each other, each type of document information being defined by a component in the schema,
characterized in that it comprises steps of analyzing (11, 13) the document structure schema (1) in order to obtain a sequence of executable instructions (5) for each component of the structure schema, comprising instructions for inserting into a bit stream control codes and compressed values of information elements or component instruction sequence call codes, and instructions for controlling the execution of the sequence as a function of control code values, execution of the instruction sequences on the structured document (2) compressing (14) the structured document (2) into a bit stream (10) containing compressed values of the information elements in the document.

2. Compression method according to claim 1, characterized in that it further comprises a step of executing instruction sequences on the structured document (2).

3. Compression method according to claim 1 or 2, characterized in that the document comprises basic elements not decomposed into sub-elements, and at least one type of basic element information is associated in advance with a compression algorithm (16) adapted to the type of information, the method comprising application of the compression algorithm (16) to the value of each information element with an information type associated with said algorithm, during execution of the instruction sequences (5).

4. Compression method according to one of claims 1 to 3, characterized in that it comprises a step of compiling (17) of instruction sequences (5) obtained for each component of said structure schema, to obtain a binary encoding program (6) dedicated to said structure schema, and directly executable or interpretable by a computer to compress a document (2) with the structure schema (1).

5. Compression method according to one of claims 1 to 4, characterized in that it comprises a prior step of normalizing (12) the document structure schema (5), so as to obtain a single predefined order of components in the schema.

6. Compression method according to one of claims 1 to 5, characterized in that it comprises a prior step (12) for optimization and simplification of the document structure schema consisting of reducing the number of nesting levels in structure components.

7. Compression method according to one of claims 1 to 6, characterized in that at least one information element in the document (2) is associated with an information element code in the generated bit stream (10), which is marked so as to enable direct access to a particular compressed information element in the bit stream, without it being necessary to decompress information elements preceding the element to be decompressed in the bit stream.

8. Compression method according to one of claims 1 to 7, characterized in that the generated compressed document (10) comprises a code for each information element in the structured document (2), used to determine the type of information associated with the information element and the binary value of the information element.

9. Compression method according to one of claims 1 to 8, characterized in that the structure schema (1) of the document (2) comprises the definition of sub-types of at least one type of information, and in that the instructions sequence (5) generated for a component of a type (TX) with n sub-types (S₁, S₂, . . . , Sₙ) comprises the following in sequence:
an instruction to insert a sub-type code (“flagPoly”) representing a sub-type to be applied to an element (X) corresponding to the component in the document, associated with the size of this code as a number of bits, and
instructions to test the value of the sub-type code, each test instruction being associated with a reference to the sub-type (S₁, S₂, . . . , Sₙ) of the element (X) corresponding to the tested value of the sub-type code, and an instructions sequence generated for compression of an element (X) associated with the sub-type.

10. Compression method according to one of claims 1 to 9, characterized in that the bit stream generated for a component corresponding to several occurrences of an elements set comprising at least one information element in the document (2), comprises a predefined end code.

11. Compression method according to one of claims 1 to 10, characterized in that each component of the structure schema (1) corresponds to an elements set in the document (2) comprising at least one information element, and is also associated with a set of numbers of possible occurrences, indicating the number of times that an elements set corresponding to this component may appear in an information element at a level immediately higher than the level to which it belongs.

12. Compression method according to claim 11, characterized in that the instructions sequence generated for a component with a number of occurrences equal to 0 or 1 comprises, in sequence:
an instruction to insert a presence code (“flagX”) on one bit indicating whether or not an elements (X) set corresponding to the component is present in the document (2),
an instruction to test the value of the presence code, and
in association with the test instruction, if the value of the presence code indicates the presence of the elements set (X) in the document, an instructions sequence generated for the component, independently of the associated number of occurrences.

13. Compression method according to claim 11 or 12, characterized in that the instructions sequence generated for a component with a number of occurrences between n and m includes the following steps in sequence:
an instruction to insert a number of occurrences code (“loopflagX”) indicating the number of successive occurrences of an elements set (X) corresponding to the component in the compressed document, minus the minimum number n of occurrences, associated with the size of this code as a number of bits,
a loop instruction defining a number of iterations corresponding to the value of the number of occurrences codes, and
in association with the loop instruction, an instructions sequence that is generated for the component independently of the associated number of occurrences.

14. Compression method according to claim 13, characterized in that the instructions sequence generated for a component with a number of occurrences between 0 and m also comprises:
an instruction to insert a presence code (“shuntflagX”) indicating whether or not there is at least one occurrence of the elements set (X) corresponding to the component in the document, and
an instruction to test the value of the presence code associated with the instructions sequence generated for a number of occurrences of the component between 1 and m, if the value of the presence code indicates that at least one elements set is present.

15. Compression method according to claim 11, characterized in that the instructions sequence generated for a component with a number of occurrences between n and m includes the following steps in sequence:
an instruction to insert a single-bit presence code (“flagX”) signaling an occurrence of an elements set (X) corresponding to the component in the document (2), associated with the size of this code as a number of bits,
a loop instruction to be executed as long as the presence code to be inserted indicates that a new occurrence of the elements (X) set is present,
in association with the loop instruction, an instructions sequence generated for the component, and an instruction to insert a new single-bit presence code (“flagX”) signaling a new occurrence of the elements set (X) in the document.

16. Compression method according to one of claims 1 to 15, characterized in that each component in the structure schema (1) corresponds to an elements set comprising at least one information element, and in that the structure schema (1) of the structured document (2) comprises at least one sequence type component of ordered components, in which the order of appearance in the sequence defines the order of appearance in the document of element sets corresponding to components of the sequence type group, and in that the instructions sequence generated for a sequence comprising n components (X1, X2, . . . , Xn) comprises instruction sequences generated for each component in the sequence, successively.

17. Compression method according to one of claims 1 to 16, characterized in that each component in the structure schema (1) corresponds to an elements set comprising at least one information element, the structure schema (1) of the document to be compressed comprises at least one component of the choice components group type, each choice component corresponding to an information elements set, the component of the choice components group type corresponding in the document to one of the information sets corresponding to choice components, and in that the instructions sequence generated for a group of choice components comprising n components defining n corresponding element sets (X1, X2, . . . , Xn), comprises the following in sequence:
an instruction to insert an elements set number code (“flagChoX”) denoting which elements set among the n element sets (X1, X2, . . . , Xn) appears in the document (2), associated with the size of this code as a number of bits, and
instructions to test the value of the elements set number code, each test instruction being associated with an instructions sequence generated for the component corresponding to the elements set (Xi) corresponding to the tested value of the elements set number code.

18. Compression method according to one of claims 1 to 17, characterized in that each component of the structure schema (1) corresponds to an elements set comprising at least one information element, and in that the structure schema (1) of the document to be compressed comprises at least one unordered components group type, each component in the unordered group corresponding to an elements set and the group of the unordered group type corresponding in the document to a group containing all element sets corresponding to components of the unordered type group, in an arbitrary order, and in that the instructions sequence generated for an unordered type group comprising n components corresponding to n element sets (X1, X2, . . . , Xn) in the document, comprises the following in sequence:
an instruction to insert an elements set (Xi) number code (“flagChoX”) and denoting the next elements set appearing in the document (2) associated with the size of this code as a number of bits, and
instructions to test the value of the elements set number code, each test instruction being associated with an instructions sequence generated for the component corresponding to the elements set (Xi) corresponding to the tested value of the elements set number code, and an instructions sequence generated for an unordered type group comprising all components (X1, . . . , Xn) of the unordered group except for the component corresponding to the elements set (Xi).

19. Method for decompressing a structured document comprising information elements nested in each other and each associated with an information type, the structured document (2) being associated with at least one structure schema (1; 31, 39, 43) defining a tree-like structure of the document and comprising structure components (a3, a4, X, Y, a1, a5, a1, a2, A, B, 32, 33, 34, 40, 44, 45, 46) nested in each other, each type of document information being defined by a component of the schema,
characterized in that it comprises steps of analyzing (11, 13) the document structure schema (1) in order to obtain a sequence of executable instructions (5) for each component of the structure schema, this sequence comprising instructions for reading control codes in a bit stream forming the compressed document (10), with compressed values of information elements or call codes to component instruction sequences, and instructions for controlling the execution of the sequence as a function of the control code values, the execution of instruction sequences on the compressed document (10) restoring a document (2′) in a same format as the original document (2) and with an at least equivalent structure.

20. Decompression method according to claim 19, characterized in that it further comprises a step of executing instruction sequences (5) on the bit stream forming the document to be decompressed (10).

21. Decompression method according to claim 19 or 20, characterized in that the structured document (2) comprises basic elements not broken down into sub-elements, and at least one basic elements information type is associated with a decompression algorithm (16′) adapted to the information type, the method comprising steps of detecting an information element binary code corresponding to said information type in the bit stream during execution of instruction sequences (5) in the bit stream forming the compressed document (10), and applying the decompression algorithm to this binary code.

22. Decompression method according to one of claims 19 to 21,
characterized in that it comprises a step of compiling (17) instruction sequences (5) obtained for each component of said structure schema (1), to obtain a binary decoding program (6) dedicated to said structure schema, and directly executable or interpretable by a computer to decompress a document (10) with this structure schema.

23. Decompression method according to one of claims 19 to 22,
characterized in that it comprises a prior step for normalization (12) of the document structure schema (5), so as to obtain a single predefined order of the components of the schema.

24. Decompression method according to one of claims 19 to 23,
characterized in that it comprises a prior step (12) for optimization and simplification of the document structure schema consisting of reducing the number of hierarchical levels of structure component groups.

25. Decompression method according to one of claims 19 to 24,
characterized in that at least one information element code is identified in the bit stream of the compressed document (10), so as to enable direct access to this information element, without it being necessary to decompress information elements preceding this element in the bit stream.

26. Decompression method according to one of claims 19 to 25,
characterized in that the compressed document (10) comprises a code for each information element in the original document, to determine the information type associated with the information element and the binary value of the compressed information element.

27. Decompression method according to one of claims 19 to 26,
characterized in that the structure schema (1) of the document to be decompressed (10) comprises the definition of sub-types of at least one information type (TX), and in that the instructions sequence (5) generated for a component of a type (TX) with n sub-types (S₁, S₂, . . . , Sₙ) includes the following in sequence:
an instruction to read a sub-type code (“flagPoly”) representing a number of the sub-type to be applied to an element (X) corresponding to the component in the document, associated with the size of this code as a number of bits, and
instructions to test the value of the sub-type code, each test instruction being associated with a reference to the sub-type (S₁, S₂, . . . , Sₙ) of the element (X) corresponding to the value of the tested sub-type code, and an instructions sequence generated for decompression of an element (X) associated with the sub-type.

28. Decompression method according to one of claims 19 to 27,
characterized in that the end of a group of several occurrences of an elements set comprising at least one information element corresponding to a component of the schema (1), is marked in the bit stream of the compressed document (10) by a determined binary code.

29. Decompression method according to one of claims 19 to 28,
characterized in that each component in the structure schema (1) corresponds to an elements set in the bit stream of the document (10), comprising at least one information element, and is also associated with a set of possible numbers of occurrences, indicating the number of times that an elements set corresponding to this structure component can appear in the information element at a level immediately above the level to which it belongs.

30. Decompression method according to claim 29,
characterized in that the instructions sequence generated for a component with a number of occurrences equal to 0 or 1 comprises the following in sequence:
an instruction to read a single-bit presence code (“flagX”) indicating whether or not an elements set (X) corresponding to the component is present in the compressed document,
an instruction to test the value of the presence code, and
in association with the test instruction, if the value of the presence code indicates that the elements set (X) is present in the compressed document, an instructions sequence that is generated for the component independently of the associated number of occurrences.

31. Decompression method according to claim 29 or 30,
characterized in that the instructions sequence generated for a component with a number of occurrences between n and m comprises the following in sequence:
an instruction to read a number of occurrences code (“loopflagX”) indicating the number of successive occurrences in the compressed document of an elements set (X) corresponding to the component, minus the minimum number n of occurrences associated with the size of this code as a number of bits,
a loop instruction defining a number of iterations corresponding to the value of the number of occurrences code, and
in association with the loop instruction, an instructions sequence generated for the component, independently of the associated number of occurrences.

32. Decompression method according to claim 31,
characterized in that the instructions sequence generated for a component with a number of occurrences between 0 and m also comprises:
an instruction to read a single-bit presence code (“shuntflagX”) indicating whether or not there is at least one occurrence of an elements set (X) corresponding to the component in the compressed document, and
an instruction to test the value of the presence code, associated with the instructions sequence generated for a number of occurrences of the component between 1 and n, if the value of the presence code indicates that there is at least one elements set present.

33. Decompression method according to claim 29, characterized in that the instructions sequence generated for a component with a number of occurrences between n and m comprises the following successively:
an instruction to read a single-bit presence code (“flagX”) indicating whether or not there is an occurrence of an elements set (X) corresponding to the component in the compressed document (10), associated with the size of this code as a number of bits,
a loop instruction to be executed as long as the presence code read in the bit stream of the compressed document indicates that there is a new occurrence of the elements set (X),
in association with the loop instruction, an instructions sequence generated for the component, and an instruction to insert a new single-bit presence code (“flagX”) indicating whether or not there is a new occurrence of the elements set (X) in the compressed document (10).

34. Decompression method according to one of claims 19 to 33,
characterized in that each component of the structure schema (1) corresponds to an elements set comprising at least one information element, and the structure schema (1) of the compressed document (10) comprises at least one ordered components sequence type component, for which the order of appearance in the sequence defines the order of appearance of element sets in the document corresponding to components of the sequence type group, and in that the instructions sequence generated for a sequence comprising n components (X1, X2, . . . , Xn) comprises instruction sequences generated for each component in the sequence successively.

35. Decompression method according to one of claims 19 to 34,
characterized in that each component in the structure schema (1) corresponds to an elements set comprising at least one information element, in that the structure schema (1) of the document to be decompressed comprises at least one component of the choice components group type, each choice component corresponding to an information elements set, the component of the choice components group type in the document corresponding to one of the information sets corresponding to the choice components, and in that the instructions sequence generated for a choice components group comprises n components (X1, X2, . . . , Xn) defining n element sets respectively, comprises the following in sequence:
an instruction to read an elements set number code (“flagChoX”) denoting the elements set that appears in the document among the n element sets (X1, X2, . . . , Xn), associated with the size of this code as a number of bits, and
instructions to test the value of the elements set number code, each test instruction being associated with an instructions sequence generated for the component corresponding to the elements set (Xi) corresponding to the tested value of the elements set number code.

36. Decompression method according to one of claims 19 to 35,
characterized in that each component in the structure schema (1) corresponds to an elements set comprising at least one information element, and the structure schema (1) of the document to be decompressed comprises at least one component of the unordered type group, each component in the unordered group corresponding to an elements set and the group of the unordered group type corresponding to a group in the document, containing all element sets corresponding to components of the unordered type group, in an arbitrary order, and in that the instructions sequence generated for an unordered type group comprising n components corresponding to n element sets (X1, X2, . . . , Xn) in the document, comprises the following successively:
an instruction to read a number code for an elements set (Xi) and denoting the next elements set appearing in the document (10), associated with the size of this code as a number of bits, and
instructions to test the value of the elements set number code, each test instruction being associated with an instructions sequence generated for the component corresponding to the elements set (Xi) corresponding to the tested value of the elements set number code, and an instructions sequence generated for an unordered type group comprising all components (X1, . . . , Xn) in the unordered group except for the component corresponding to the elements set (Xi).
